(19) United States
(12) Patent Application Publication
(10) Pub. No.: US 2005/0061926 A1
(43) Pub. Date: Mar. 24, 2005

(54) Fastener for a tube-wire condenser

(76) Inventors: Alexsandro J Pereira, Joinville-SC (BR); Jaime King Chin, Joinville- SC (BR); Anderson Bortoletto, Joinville-SC (BR); Carlos Alberto Fenandes de Souza, Joinville-SC (BR)

Correspondence Address: DARBY & DARBY P.C., P. O. BOX 5257, NEW YORK, NY, 10150-5257, US

(21) Appl. No.: 10/503,260

(22) PCT Filed: Feb. 14, 2003
(86) PCT No.: PCT/BR03/00019

(30) Foreign Application Priority Data
Feb. 18, 2002 (BR) MU8200280-0

(51) Int. Cl. F16B 15/00

(52) U.S. Cl. 248/71

(57) ABSTRACT

A fastener for a tube-wire condenser to be affixed to a wall (3) of the cabinet (G) of a refrigerator or freezer and comprising tubular extensions (2) which are coplanar and spaced from each other, and two alignments of wires (1) which are tangentially and orthogonally affixed to opposite sides of the tubular extensions (2). Said fastener (10) incorporates a pair of legs (13) provided with respective end portions (15) defined between a pair of opposite lateral flaps (14) and a widened end head (16), each end portion (15) being orthogonally introduced between consecutive wires (1) of the two alignments of wires, each end portion presenting, on opposite sides and close to the widened end head (16) and to the lateral flaps (14), a recess (17, 18) for the tight seating of a respective wire (1), each lateral flap (14) further presenting an end housing for the tight seating of another wire (1) disposed in the alignment of wires, against which are seated the lateral flaps (14).

### FIELD OF THE INVENTION

The present invention refers to a new construction for a fastener to be utilized in the fixation of a tube-wire condenser generally on the rear part of the cabinet of a refrigerator or freezer.

### PRIOR ART

The condenser of the tube-wire type comprises a refrigerant fluid conducting tube, which is curved so as to present a plurality of rectilinear tubular extensions, which are parallel, spaced from each other and disposed in the same vertical plane, in order to be maintained at a certain distance from the rear wall of the cabinet of a refrigerator or freezer. The tubular extensions are sequentially connected in series by means of end tubular curves and disposed between two rectilinear alignments of wires that are tangentially and orthogonally welded to the tubular extensions on opposite sides of the latter, said wires lying parallel to each other in two vertical planes tangent to the tubular extensions.

In a known construction of a tube-wire condenser that is schematically partially illustrated in FIG. 2 of the enclosed drawings, the wires 1 of both alignments are disposed in pairs, the wires 1 of each pair being aligned according to a plane orthogonal to the plane of the tubular extensions 2.

In this type of construction, the fixation of the condenser to a wall 3, generally the rear wall of the cabinet G of the refrigerator or freezer is obtained by fasteners 10, generally in the number of four and made of a plastic material, comprising a generally U shaped body with a basic portion 11 incorporating a median extension 12, which is fitted and retained through the wall 3 of the cabinet G, and a pair of mutually spaced legs 13, each carrying a pair of small lateral flaps 14 opposite to each other and delimiting the base of an end portion 15 provided with a widened end head 16 which is generally tapered. Each end portion 15 is shaped in order to define, on opposite sides and close to the widened end head 16 and to the lateral flaps 14, a recess 17, 18 for the tightly seating (with no gaps) of a respective wire 1 of the condenser, when between two consecutive pairs of wires 1 is introduced an end portion 15 of the fastener 10, as schematically illustrated in FIG. 2.

In the construction described above and illustrated in FIG. 2, the two legs 13 of each fastener 10 are spaced from each other so that their end portions 15 are each fitted between two consecutive pairs of wires 1 that are spaced from the two pairs of wires 1 that receive the end portion 15 from the other of said legs 13. After fitting each end portion 15 between the respective pairs of wires 1, the widened head 16 and the lateral flaps 14 remain seated on the adjacent pair of wires 1 disposed on a respective side of the tubular extensions 2. Thus, the condenser is retained to the fastener 10 against horizontal movements in both the orthogonal and parallel directions in relation to the plane of the adjacent wall 3 of the cabinet G. The lateral flaps 14 are thus seated on the respective adjacent pair of wires 1 on the same side of the tubular extensions 2, with at least one of the lateral flaps 14 being dimensioned to be seated on at least two wires 1.

While adequately operating to provide the fixation of a tube-wire condenser with the wires 1 being arranged in pairs aligned orthogonally to the plane of the tubular extensions 2, this known fastener 10 illustrated in FIGS. 1, 2 and 3 is not adequate for providing the fixation of a tube-wire condenser in which the wires 1 of one side of the tubular extensions 2 are not aligned with respective wires 1 of the other side of said tubular extensions 2, as illustrated in FIG. 3.

This type of tube-wire condenser with disaligned wires does not have a stable and safe fixation when applied to the fasteners 10 normally utilized in the condensers with aligned wires. FIG. 3 illustrates this hypothetical situation, in which each end portion 15 of the fastener 10 would be fitted only between two opposite and offset wires 1, with only one of the lateral flaps 14 being seated on a single wire 1.

By reason of the instability of the type of assembly illustrated in FIG. 3, it is usually provided one type of fastener 10 for each of the two types of assemblies of the wires 1 to the tubular extensions 2, requiring distinct molds and parts to comply with both models of tube-wire condenser.

### OBJECT OF THE INVENTION

As a function of the disadvantage mentioned above, it is an object of the present invention to provide a fastener for the fixation of a tube-wire condenser to a wall of the cabinet of a refrigerator or freezer, which assures a safe and stable assembly, regardless of the fact of the condenser presenting wires disposed in pairs orthogonally aligned to the plane of the condenser, or wires that are offset on both sides of the rectilinear tubular extensions of the condenser.

### SUMMARY OF THE INVENTION

The present fastener is applied to a condenser of the type mentioned above and comprises a basic portion to be affixed to the cabinet of the refrigeration appliance, and incorporating a pair of legs provided with respective end portions, which are defined between a widened end head and a pair of lateral flaps and introduced between consecutive wires of the two alignments of wires, so that the widened end head and the lateral flaps remain externally seated against respective alignments of wires. Each end portion presents, on opposite sides and close to the widened end head and to the lateral flaps, a recess for the tight seating of a respective wire.

According to the invention, each lateral flap further presents an end housing for the tight seating of a wire disposed in the alignment of wires, against which are seated the lateral flaps and in a position adjacent to that of the wires to be seated in the recesses disposed on the same side of the end portion.

### BRIEF DESCRIPTION OF THE DRAWINGS

The invention will be described now, with reference to the enclosed drawings, in which:

FIG. 1 is a plan view of a prior art fastener;

FIG. 2 is a top plan view of a prior art fastener affixed to the partially cut rear wall of the cabinet of a freezer or refrigerator and supporting a tube-wire condenser, in which the wires are arranged in pairs, the wires of each pair being disposed on opposite sides of the tubular extensions and in an orthogonal plane in relation to the latter;

FIG. 3 is a view similar to that of FIG. 2, but illustrating the prior art fastener affixing a tube-wire condenser, in which the wires disposed on one side of the tubular extensions are not aligned with the respective wires of the other side;

FIG. 4 is a plan view of the fastener of the present invention;

FIG. 5 is a perspective view of the new fastener illustrated in FIG. 4;

FIG. 6 is a view similar to that of FIG. 2, but illustrating the new fastener when adapted to a condenser with wires arranged in aligned pairs; and

FIG. 7 is a view similar to that of FIG. 3, but illustrating the application of the new fastener to a condenser in which the wires are offset from each other.

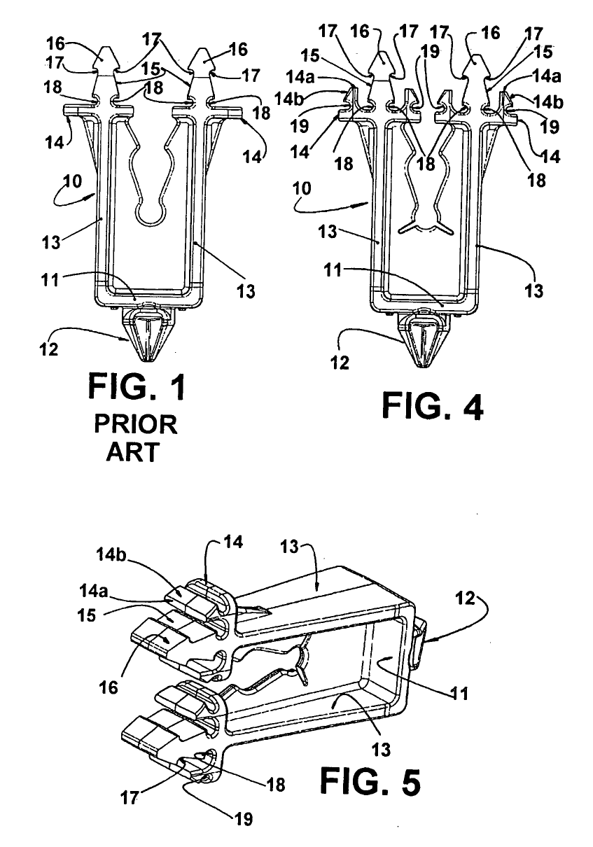

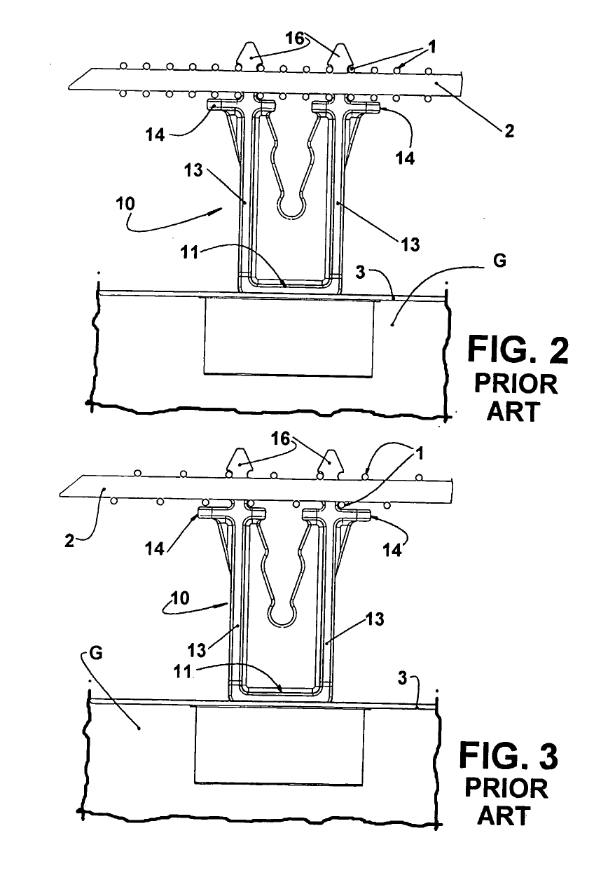

### DESCRIPTION OF THE ILLUSTRATED EMBODIMENT

As already previously described and illustrated in FIGS. 4-7 of the enclosed drawings, the fastener 10 of the present invention comprises a basic portion 11 incorporating, in a single piece generally made of an injected plastic material, a median extension 12 in the form of a pin with a widened head to be introduced and retained in a hole produced in the wall 3 of the cabinet G, like in any known prior art constructive arrangement. Generally, the widened head of the median extension 12 is introduced, by elastic deformation, through a hole of a reinforcing plate incorporated to the inside of the wall 3 of the cabinet.

The arrangement for the fixation of the fastener 10 to the cabinet G should be made so as to allow an adequate positioning and also a safe and stable seating of the basic portion 11 against the wall 3 of the cabinet G.

The basic portion 11 further incorporates on an opposite side to that of the median extension 12, a pair of legs 13 which are mutually spaced and disposed side by side, each carrying a pair of lateral flaps 14 which are opposite to each other and delimiting the base of an end portion 15, which is provided with a widened end head 16 that is generally tapered.

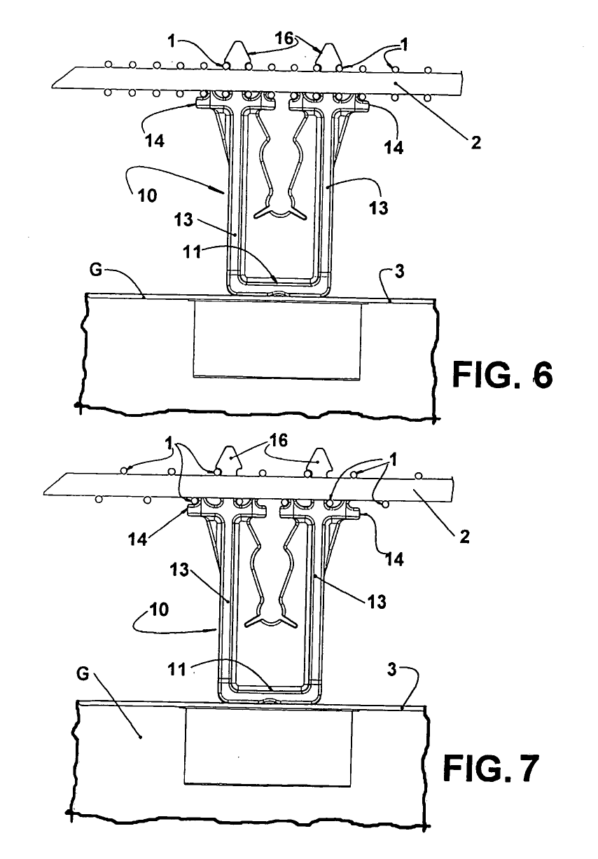

As illustrated in FIGS. 6 and 7, each end portion 15 is introduced between the consecutive wires 1 of the two alignments of wires, in order to seat the lateral flaps 14 and the widened end head 16 against respective external sides of the two alignments of wires.

The widened end head 16 presents a basic width that is larger than the free distance between two consecutive wires of the two alignments of wires, the same occurring with the end portion 15, which presents at least in a region close to the lateral flaps 14, a width that is slightly larger than said distance between the consecutive wires 1.

Thus, the orthogonal introduction of each end portion 15 through the two alignments of wires is achieved by the elastic deformation of at least one of the parts in mutual contact defined by the wires 1 and by the fastener 10.

Each end portion 15 of the fastener 10 is provided, on opposite sides and close to the widened end head 16 and to the lateral flaps 14, with a recess 17, 18 in which is tightly seated a respective wire 1 upon the introduction of the end portion 15 through the two alignments of wires.

When the condenser is of the type that presents the wires 1 of the two alignments disposed in pairs aligned orthogonally to the condenser plane, such as it occurs in FIG. 6, each of the recesses 17, 18 receives a respective wire 1.

However, when the condenser is of the type in which the wires 1 of the two alignments of wires are offset from each other, as it occurs in the construction of FIG. 7, only one of the recesses 17, 18 of each pair, which is adjacent respectively to the widened end head 16 and to the lateral flaps 14, receives a wire 1, the two retained wires, one from each alignment, being disposed on opposite sides of the respective end portion 15. In this situation, an adequate stability in the fixation of the condenser is not achieved.

The fastener 10 foreseen in the present innovation has each lateral flap 14 provided with an end housing 19 for the tight seating of another wire 1 disposed in the alignment of wires, against which are seated the lateral flaps 14, and located in a position adjacent to that of the wire, or wires 1, to be seated in the recesses 17, 18 disposed on the same side of the end portion 15, as better illustrated in FIG. 7.

The seating of one of the lateral flaps 14 in one more wire 1, in each of two legs 13, allows obtaining a safe and stable fixation of the condenser to the fastener 10, even in the case of condensers with offset wires.

As it can be noted in FIG. 6, the new construction for the fastener 10 can be also applied to the condensers with wires in aligned pairs. In this case, besides the fact that each of the recesses 17, 18 receives a respective wire 1, in the end housing 19 of each lateral flap 14 there is also seated another wire 1 of the alignment of wires onto which are seated the lateral flaps 14.

In the preferred and illustrated embodiment, the recesses 18 adjacent to the lateral flaps 14 have a semi-circular cross section turned laterally outwardly, generally in a position that is opened in a direction orthogonal to the axis of the respective end portion 15.

Similarly, the end housings 19 of the lateral flaps 14 also present a semi-circular form turned laterally outwardly and they are arranged in a position that is generally symmetric and aligned in relation to the recesses 18 adjacent to the lateral flaps 14.

Each end housing 19 is also separated from the adjacent recess 18 by a salience 14a incorporated to the respective lateral flap 14, said salience being generally provided with an external lateral face in the form of a ramp 14b that ends in an edge of the adjacent end housing 19.

As already known, the widened end head 16 and the end portion 15 itself of each leg 13 are laterally tapered so that, jointly with the lateral face in the form of a ramp 14b of the salience 14, to facilitate the introduction of the end portion 15 between the alignments of wires, elastically deforming said wires until they reach the respective recesses 17, 18 and the end housings 19, in which they will remain tightly seated with only a slight or no elastic deformation.

1. A fastener for a tube-wire condenser to be affixed to a wall (3) of the cabinet (G) of a refrigerator or freezer and comprising tubular extensions (2), which are coplanar and spaced from each other, and two alignments of wires (1) which are tangentially and orthogonally affixed to opposite sides of the tubular extensions (2), said fastener (10) comprising a basic portion (11) to be affixed to said wall (3) and incorporating a pair of legs (13), each carrying a pair of opposite lateral flaps (14) and delimiting the base of an end portion (15) provided with a widened end head (16), each end portion (15) being orthogonally introduced, by the elastic deformation of at least one of the contacting parts, between consecutive wires (1) of the two alignments of wires, in order to seat the lateral flaps (14) and the widened end head (16) externally against a respective alignment of wires (1), each end portion (15) presenting, on opposite sides and close to the widened end head (16) and to the lateral flaps (14), a recess (17,18) for the tight seating of a respective wire (1), characterized in that each lateral flap (14) further presents an end housing (19) for the tight seating of a wire (1) disposed in the alignment of wires, against which are seated the lateral flaps (14) and in a position adjacent to that of the wires (1) to be seated in the recesses (17,18) disposed on the same side of the end portion (15).

2. The fastener according to claim 1, characterized in that the recesses (18) of the end portion (15) that are adjacent to the lateral flaps (14) have a semi-circular form turned laterally outwardly.

3. The fastener according to claim 2, characterized in that the recesses (18) adjacent to the lateral flaps (14) are opened to a direction orthogonal to the axis of the respective end portion (15).

4. The fastener according to claim 1 characterized in that the end housings (19) of the lateral flaps (14) have a semi-circular form turned laterally outwardly.

5. The fastener according to claim 4, characterized in that the end housings (19) are aligned and symmetric in relation to the recesses (18) adjacent to the lateral flaps (14).

6. The fastener according to claim 5, characterized in that each end housing (19) is separated from the adjacent recess (18) by a salience (14a) incorporated to the respective lateral flap (14).

7. The fastener according to claim 6, characterized in that each salience (14a) presents an external lateral face in the form of a ramp (14b) that ends in an edge of the adjacent end housing (19).

8. The fastener according to claim 2 characterized in that the end housings (19) of the lateral flaps (14) have a semi-circular form turned laterally outwardly.

9. The fastener according to claim 3 characterized in that the end housings (19) of the lateral flaps (14) have a semi-circular form turned laterally outwardly.
